(19) United States
(12) Patent Application Publication
(10) Pub. No.: US 2007/0058113 A1
(43) Pub. Date: Mar. 15, 2007

(54) Barrier device of a three-dimensional liquid crystal display

(75) Inventors: Yi-Chun Wu, Hualien City (TW); Wen-Jui Liao, Taichung County (TW); Fa-Chen Wu, Yunlin County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/223,043

(22) Filed: Sep. 12, 2005

(51) Int. Cl. G02F 1/1335

(52) U.S. Cl. 349/106

(57) ABSTRACT

A barrier device of a three-dimensional liquid crystal display (3D LCD) device, which aims to the pixels on the color filter, the barrier panel equips plural parallax barriers. Each of the barriers is grille array, and not transparent. There is a transparent area between two parallax barriers. The parallax barriers in the adjacent arrays are formed diagonally, and the width of the transparent area is greater than that of a sub-pixel in order to reduce the number of the parallax barriers, to enhance the luminance of the 3D LCD, and to preserve the resolution of the 2D-display images.

### FIELD OF THE INVENTION

The present invention relates to a method that aims to the resolution and the luminance of a 3D LCD (three-dimensional liquid crystal display), mainly aims to the arrangement of the parallax barriers by reducing the number of the parallax barriers to enhance the luminance of the images, and by way of the mixed-color arrangement for sub-pixels to preserve the resolution of the 2D-display images.

### BACKGROUND OF THE INVENTION

Human eyes are used to 3D images in daily life so the frames including movies and other displays are supposed to be 3D pictures. However, it is surprising that the subconscious requirement is not satisfied due to the obstacle of technology for a long time, and human eyes accept 2D pictures without any resistance.

Usually, a 3D display device has a complicated structure and the displayed quality is not satisfactory. In other words, most 3D displays need special glasses or change the way of input, hence the operators need to be trained. After the developments of many companies, prototypes for 3D displays are issued continually. The 3D displays without 3D glasses can be manufactured now.

As shown in FIG. 1, it presents a schematic flowchart for a well-known 3D display producing 3D pixels. The well-known method is to adopt an image splitter 12. By utilizing this kind of image splitter 12, people can watch 3D dynamic images. Basically, it bases on the parallax barrier theorem that makes images in an alternate arrangement. After passing through the thin column raster, the direction of the light that emitted by each pixel of LCD 11 is controlled, and then is observed by two eyes. Because the transversal images enter the left and right eye were split by parallax barrier, it results in a small deviation between the image pixels captured by the left eye and right eye. Because the overlap-cancellation mode for these two images is the same as the mode for when human eyes observe these two images normally, the brain naturally recognizes these two images as different images such that the “depth perception” effect is induced. Finally, the retina reads 15 them as 3D images. Therefore, when the sight is focused on the front of the display, the two eyes of the observer can receive correct images and then pass them to the brain for processing. By way of this, the pictures on displays can achieve the 3D effect without any special glasses.

A 2D/3D transformable 3D display utilizes a kind of LCD as the parallax barrier. The principle is that an LCD is used as a barrier panel in front of the original display. The barrier panel is a 3D display system placed between the display screen and the backlight source, and the barrier panel can be switched to be the display without the parallax barrier. The 2D/3D transformation is done by the shelter of the parallax barrier. When the 3D effect is switched off, the parallax barrier in the middle will become transparent and has no function of sheltering light such that the display effect is the same as a common 2D display. At the 3D display mode, the system provides the left and right eye individual images so as to produce the 3D effect for the pictures on the display.

At present, the 2D to 3D display in the market equips a switch LCD between an observer and the color filter 21 of the LCD. When the system is switched to the 3D mode, the switch LCD has stripes and equal interval between the parallax barriers 22 (as shown in FIG. 2). When the 2D images of the stripe array color filters 21 are transformed to the 3D images, through the splitting by the parallax barrier 22 and then passed to the left and right eye respectively to produce the parallax such that the 3D display is realized. But this method is same as the well-known method, the present problem is that separating a plane image into left and right will result in decreasing resolution and backlight transmissivity at least 50% for 3D display compared with those for 2D display, which affects the display effect.

Referring to FIG. 2, there are 45 sub-pixels originally. When the parallax barrier 22 on the switch LCD activates, there are 24 light-sheltering barriers. At this time, the transversal images entered the left and right eye emitted by each pixel were split by the parallax barrier, sub-pixels were used alternately. This means that the horizontal resolution degrades half (as shown in FIG. 3). Take the vision seen by the left eye as an example, the number of pixels for the same-sized area of the original 2D display will decrease (the occupied area for a pixel increases), which reduces the resolution and backlight transmissivity about 50%. In other words, a traditional 2D/3D LCD will reduce the resolution and backlight transmissivity about 50% while 2D images are transformed to 3D images.

### SUMMARY OF THE INVENTION

Consequently, the main purposes of the present invention are reducing the number of the parallax barrier, enhancing the image resolution and light transmissivity of a traditional 3D LCD, and improving the drawbacks that the resolution and backlight transmissivity drop while 2D images are transformed to 3D images of a display.

Another purpose of the present invention is that by way of the special arrangement for the parallax barriers to split a part of lights into two beams when the parallax barriers of the LCD are activating (shelter light), and the two beams enter the left and right eye respectively to form the parallax so as to achieve the 3D effect. At the same time, sub-pixels utilize the delta array or mosaic array sub pixel rendering to make the 3D image resolution of the present invention greater than that of the conventional and even preserve the resolution under 2D mode so as to achieve the effect of unchanged resolution.

The present invention is a barrier device of a 3D LCD for the color filters on the LCD device. The arrangement of the color filters has plural pixels, and each pixel ranks plural sub-pixels. The upper/lower side of the barrier panel is relative to the color filter. The barrier panel equips plural parallax barriers that are grille array and not transparent. There is a transparent area between two parallax barriers, where the parallax barriers in the adjacent arrays are formed diagonally, and the width of the transparent area is greater than that of a sub-pixel.

The parallax barrier is treated as a light splitter. Lights are split into two beams when passing through the parallax barrier. The two beams enter the left and right eye of the observer respectively to form the parallax so as to achieve the 3D effect. At the same time, sub-pixels utilize the delta array or mosaic array sub pixel rendering to make the 3D image resolution greater than the traditional 3D image resolution and even preserve the resolution under 2D mode.

Further, reducing the number of the parallax barriers appropriately can substantially improve the drawback of the insufficient luminance, i.e. improving the transmissivity of the whole display panel and increasing the luminance and resolution of the display panel.

### BRIEF DESCRIPTION FOR THE DRAWINGS

FIG. 1 is the schematic flowchart for a well-known 3D display producing 3D pixels.

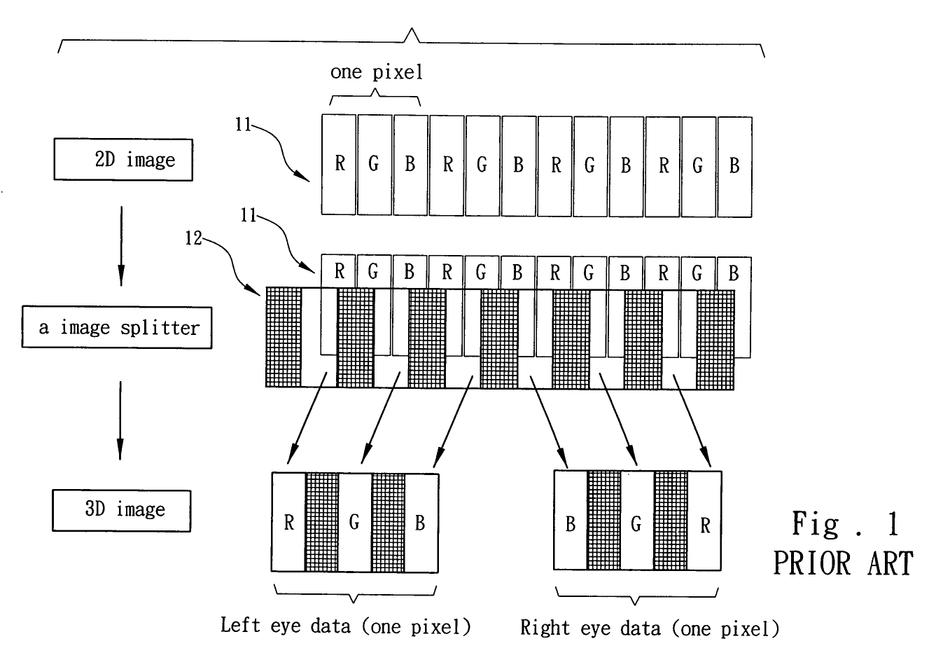

FIG. 2 is the schematic diagram for the well-known relative locations between the parallax barriers and the color filters.

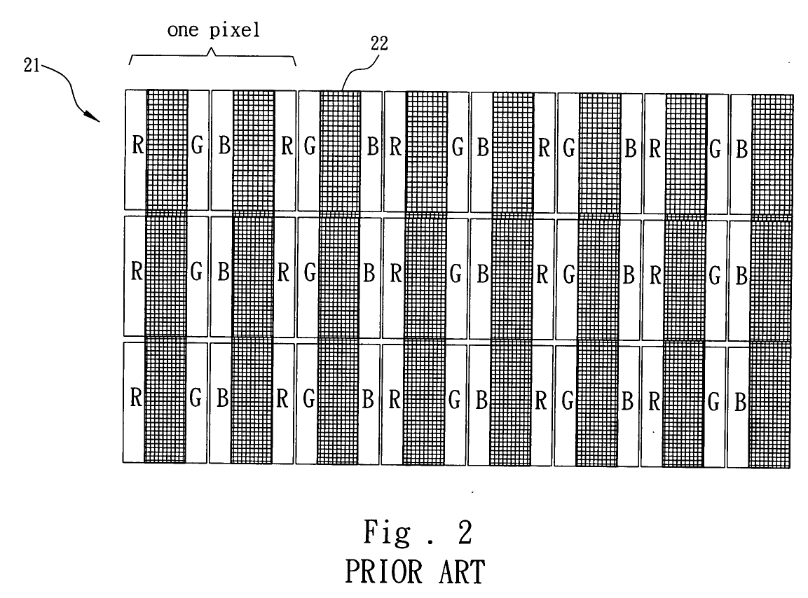

FIG. 3 is the schematic diagram for the well-known pixels seen by left eyes.

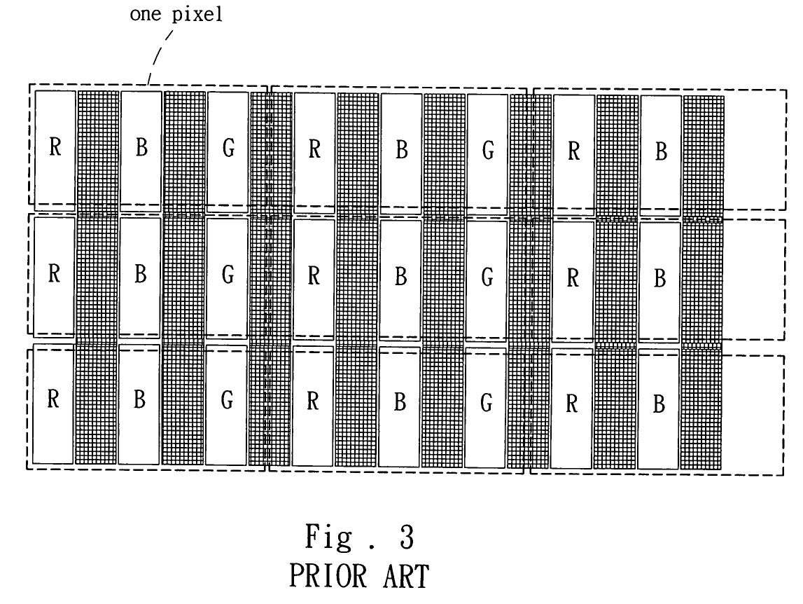

FIG. 4 is the schematic diagram for the color filter of a pixel that includes red, green, and blue three sub-pixels.

FIG. 5 is the schematic diagram for the arrangement of the parallax barriers in FIG. 4 of this invention.

FIG. 6 is the schematic diagram for the relative locations between the color filters in FIG. 4 and the parallax barriers in the FIG. 5.

FIG. 7 is the schematic diagram for the pixels seen by the left eye of an observer for FIG. 6.

FIG. 8 is the schematic diagram for the pixels seen by left and right eyes of an observer for FIG. 6.

FIG. 9 is the schematic diagram for the color filter of a pixel that includes red, green, blue, and white four sub-pixels.

FIG. 10 is the schematic diagram for the arrangement of the parallax barriers in FIG. 9 of this invention.

FIG. 11 is the schematic diagram for the relative locations between the color filters in FIG. 9 and the parallax barriers in the FIG. 10.

FIG. 12 is the schematic diagram for the pixels seen by left eyes for FIG. 11.

FIG. 13 is the schematic diagram for the pixels seen by right eyes for FIG. 11.

### DETAILED DESCRIPTION OF THE PREFERRED EMBODIMENTS

The detailed descriptions for content and technology of this invention associate with figures are as follows.

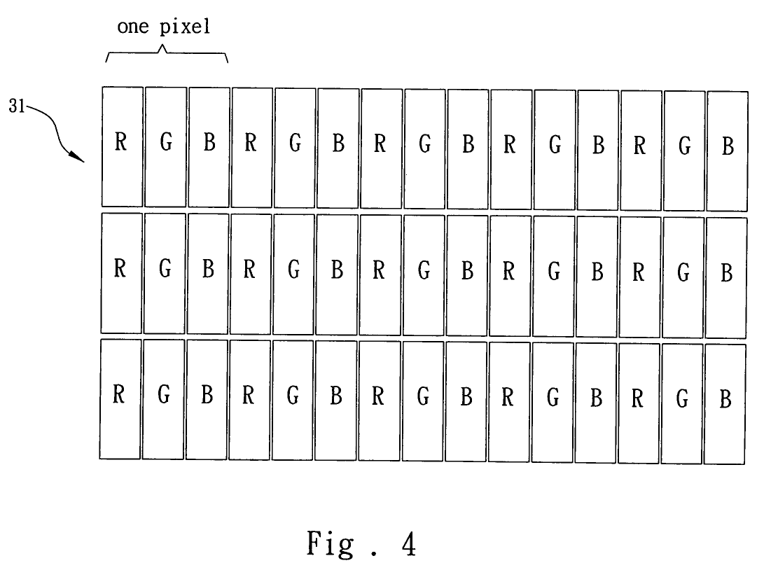

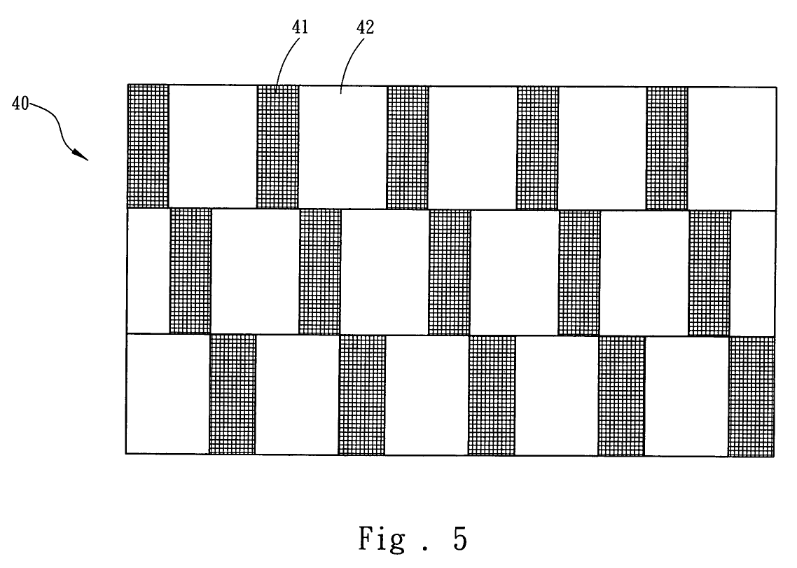

Please refer to FIGS. 4 and 5 together. A color filter 31 on the LCD device of this invention has plural pixels, and each pixel ranks plural sub-pixels (as shown in FIG. 4, a pixel includes red, green, and blue three sub-pixels). A barrier panel 40 (as shown in FIG. 5) is located at the up of the LCD device that includes the color filter 31, or is located at the down of the LCD device that includes the color filter 31.

The barrier panel 40 equips plural parallax barriers 41 that are grille array and not transparent. The parallax barriers 41 are relative to the pixel of the color filter, and there is a transparent area 42 between two parallax barriers 41 respectively. Moreover, the parallax barriers 41 in the adjacent arrays of the barrier panel 40 are formed diagonally in the same direction, and the width of the transparent area 42 is greater than that of a sub-pixel. Regarding the pixel including red, green, and blue three sub-pixels in FIG. 4, the arrangement for the parallax barrier 41 of the barrier panel 40 is that the interval between two adjacent parallax barriers is approximate the width of two sub-pixels.

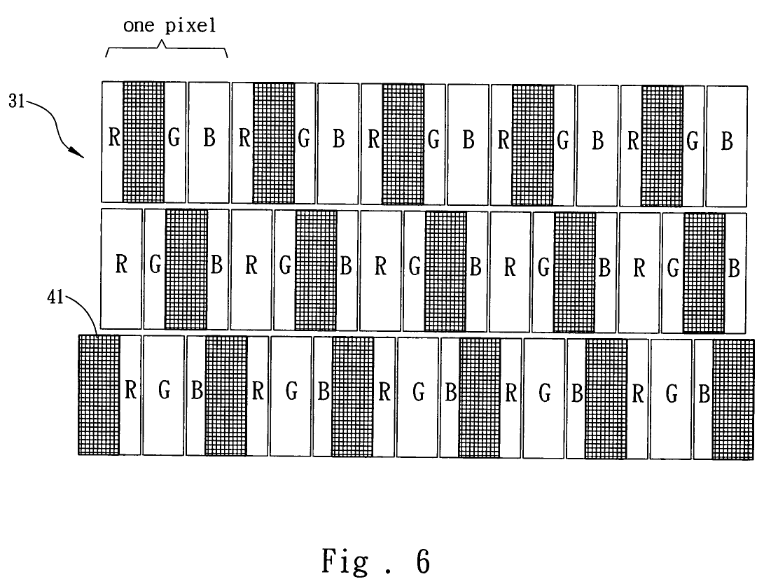

FIG. 6 illustrates the relative location for the parallax barrier 41 and the pixel on the color filter 31. Each parallax barrier 41 is located between two sub-pixels relatively; the parallax barriers 41 in the adjacent arrays of the barrier panel 40 are formed diagonally in the same direction, and the interval between two parallax barriers 41 is the width of two sub-pixels. As a result, by way of reducing the number of parallax barriers 41 and relatively arranging the sub-pixels of the color filter 31 appropriately, the 2D images are transformed to 3D images of an LCD. At the same time this invention improves the problems of the transmissivity and resolution degradation for a well-known technology of transforming 2D images to 3D images. Therefore, the transmissivity (luminance) and resolution of the whole 3D display is enhanced by way of reducing the sheltering barriers.

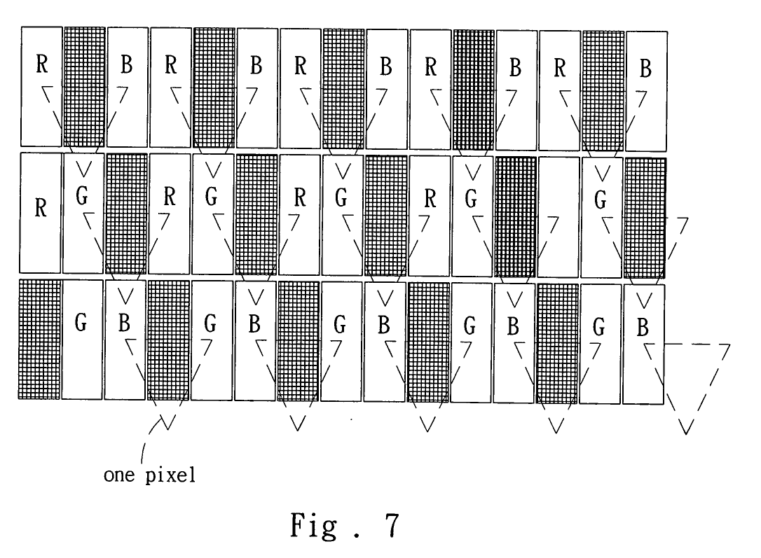

Refer to FIGS. 6 and 7. There are 45 sub-pixels on the color filter 31 originally. When the parallax barrier 41 on the barrier panel 40 is activating, the number of sheltering barrier is 15 in this invention, which is less than the number of the sheltering barrier of a traditional 3D display. Hence, the pervious luminance is substantially increased. FIG. 7 shows the example seen by the left eye. The original stripe array pixels on the 2D display will recombine the sub-pixels (R, G, B) of the adjacent pixels on the original 2D display due to the sheltering effect caused by the parallax barrier 41 arrangement of this invention. By way of the delta array or mosaic array sub pixel rendering, the pixel number of this invention still equals the pixel number of the original 2D images in the same sized area such that the resolution presented in the 3D images can be preserved as the resolution displayed in 2D mode.

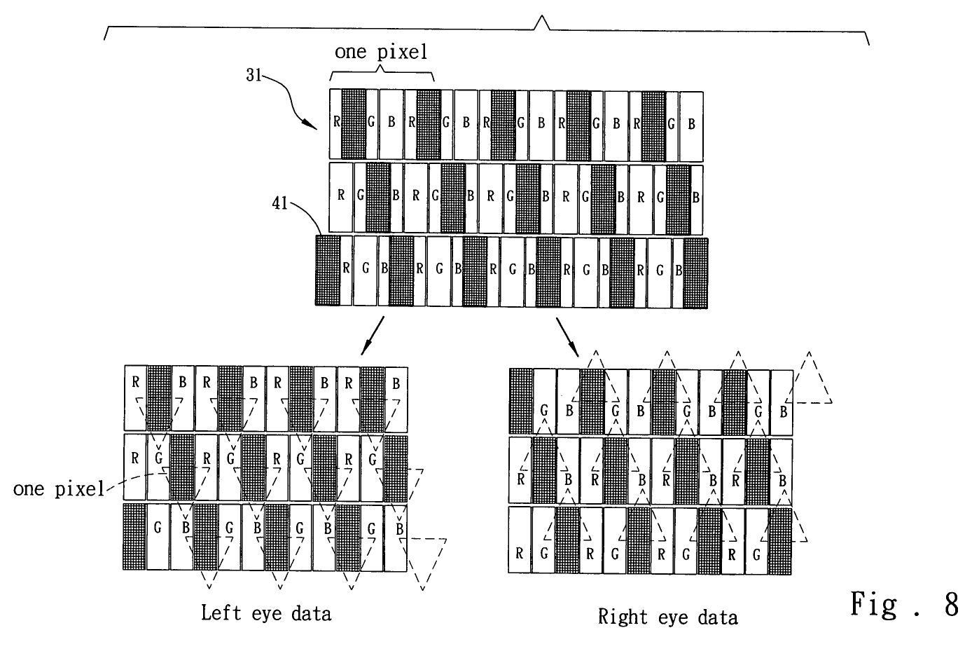

FIG. 8 is the schematic diagram for the pixels seen by left and right eyes of an observer. The parallax barrier 41 is treated as a light splitter. Lights are split into two beams when passing through the color filter 31 to the parallax barrier 41, and the two different beams enter the left and right eye of the observer respectively. According to the above mentioned, the resolutions sensed by two eyes are still the same as the resolution of the original 2D display. The image pixels captured by the left and right eye result in a small deviation, the brain of the observer naturally recognizes these two images as different images such that the “depth perception” effect is induced. Finally, the retina reads them as 3D images. Therefore, when the sight is concentrated at the front of the display, the two eyes of the observer can receive correct images and then pass them to the brain for processing. Consequently, the sub-pixels (R, G, B) of the 3D image after recombining by the brain will present the delta array or mosaic array sub pixel rendering such that the resolution presented in the 3D images can be the same as the resolution displayed in 2D mode.

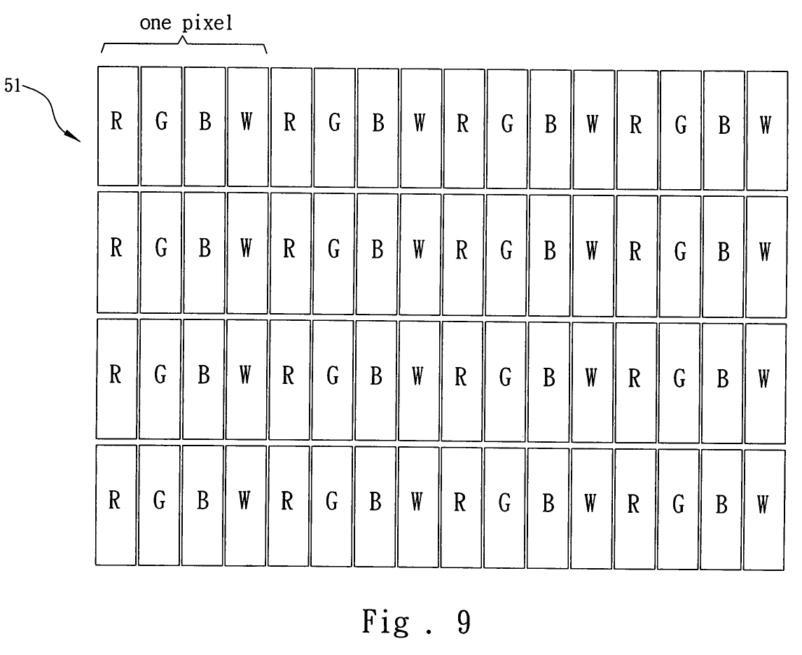

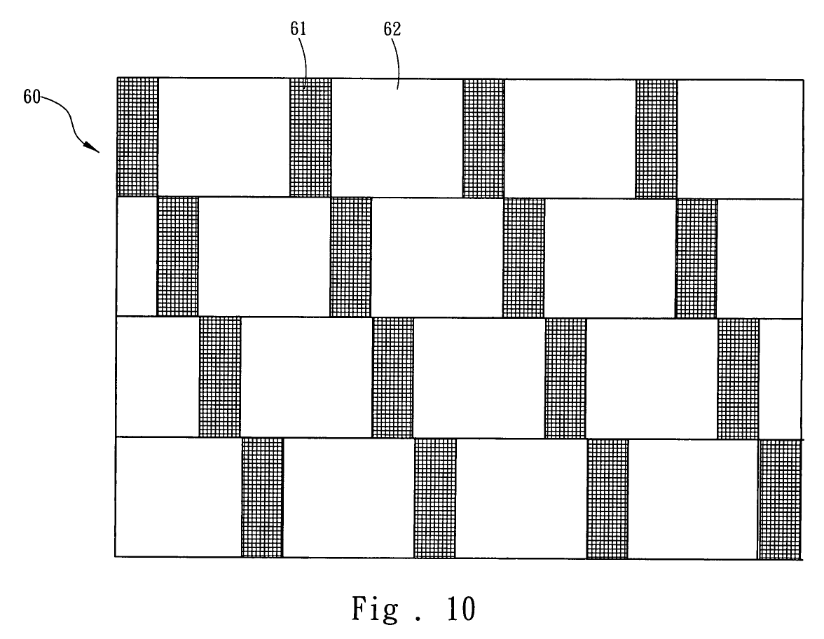

Please refer to FIGS. 9 to 11 together, the same principle is applied to the color filter 51 that arranges plural pixels and each pixel arranges red (R), green (G), blue (B), and white (W) four sub-pixels (as shown in FIG. 10). The barrier panel 60 equips plural parallax barriers 61 that are grille array and not transparent (as shown in FIG. 9). There is a transparent area 62 between two parallax barriers 61 respectively. Moreover, the parallax barriers 61 in the adjacent arrays of the barrier panel 60 are formed diagonally in the same direction, and the width of the transparent area 62 is greater than that of a sub-pixel. Regarding the color filter 51 that one pixel includes red, green, blue, and white four sub-pixels, the arrangement for the parallax barrier 61 of the barrier panel 60 is that the interval between two adjacent parallax barriers 61 is approximate the width of three sub-pixels.

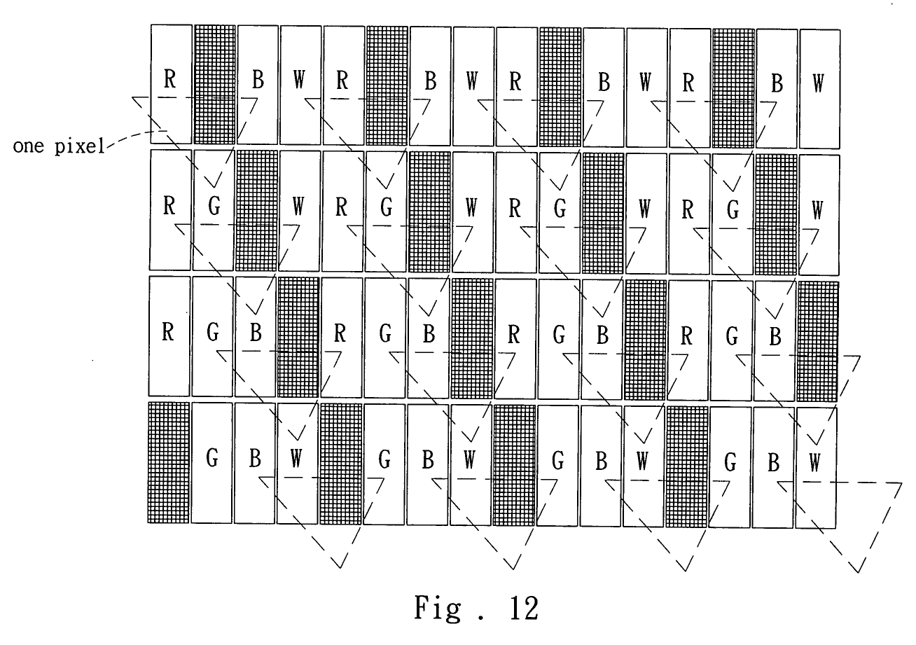

FIG. 12 shows the relative location for the parallax barrier 61 and the pixel on the color filter 51. Each parallax barrier 61 is located between two sub-pixels relatively. The parallax barriers 61 in the adjacent arrays of the barrier panel 60 are formed diagonally in the same direction, and the interval between two parallax barriers 61 is the width of three sub-pixels. As a result, by way of reducing the number of parallax barriers 61 and relatively arranging the sub-pixels of the color filter 51 appropriately, the 2D images are transformed to 3D images of an LCD. At the same time this invention improves the problems of the transmissivity and resolution degradation for a well-known technology of transforming 2D images to 3D images. Therefore, the transmissivity (luminance) and resolution of the whole 3D display is promoted by way of reducing the sheltering barriers.

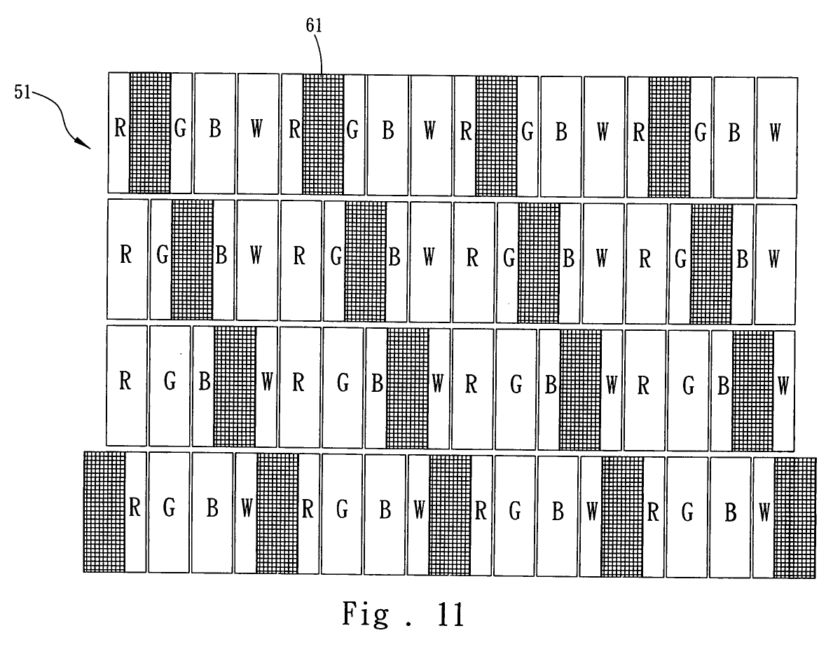

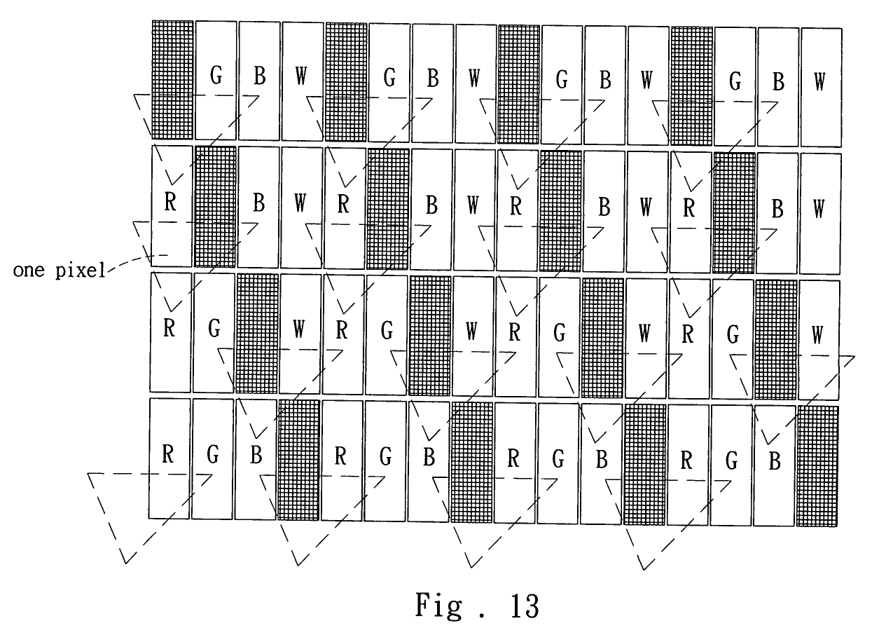

FIG. 11 shows another example. There are 64 sub-pixels on the color filter 51 originally (16 pixels). When the parallax barrier 61 on the barrier panel 60 is activating, the number of sheltering barrier is 16 in this invention, which is less than the number of the sheltering barrier of a traditional 3D display. Hence, the pervious luminance is substantially increased. FIGS. 13 and 12 show what the left eye and the right eye of the observer have been seen. The original stripe array pixels on the 2D display will recombine the sub-pixels (R, G, B, and W) of the adjacent pixels on the original 2D display due to the sheltering effect caused by the parallax barrier 61 arrangement of this invention. By way of the delta array or mosaic array sub pixel rendering, the pixel number of this invention still equals the pixel number of the original 2D images in the same sized area (for example, each of FIGS. 12 and 13 has 16 pixels) such that the resolution presented in the 3D images can be preserved as the resolution displayed in 2D mode.

Accordingly, lights are split into two beams when passing through the color filter 51 to the parallax barrier 61, and the two different beams enter the left and right eye of the observer respectively. According to the above mentioned, the resolutions sensed by two eyes are still the same as the resolution of the original 2D display. The image pixels captured by the left and right eye result in a small deviation, the brain of the observer naturally recognizes these two images as different images such that the “depth perception” effect is induced. Finally, the retina reads them as 3D images. Therefore, when the sight is concentrated at the front of the display, the two eyes of the observer can receive correct images and then pass them to the brain for processing. The sub-pixels (R, G, B, and W) of the 3D image after recombining by the brain will present the delta array or mosaic array sub pixel rendering such that the resolution of the 3D images seen by the observer at last can be the same as the resolution displayed in 2D mode.

However, the above description is only a better practice example for the present invention, which is not used to limit the practice scope of the invention. All equivalent changes and modifications based on the claimed items of this invention are in the scope of the present invention.

What is claimed is:

1. A barrier device of a three-dimensional liquid crystal display (LCD) device, comprising:
a color filter, which has plural pixels, and each pixel ranks plural sub-pixels; and
a barrier panel, which equips plural parallax barriers that are grille array and not transparent and is relative to the pixels of the color filter, and there is a transparent area between two parallax barriers respectively,
wherein the parallax barriers in the adjacent arrays are formed diagonally, and the width of the transparent area is greater than that of a sub-pixel.

2. The barrier device as claimed in claim 1, wherein the barrier panel is located at the up of the LCD device that includes the color filter.

3. The barrier device as claimed in claim 1, wherein the barrier panel is located at the down of the LCD device that includes the color filter.
